(19) United States
(12) Patent Application Publication
(10) Pub. No.: US 2015/0049633 A1
(43) Pub. Date: Feb. 19, 2015

(54) Control Method of Establishing Wireless Network Connection Through Modulation Tone

(71) Applicant: AVID Electronics Corp., Hsinchu City (TW)

(72) Inventor: Tain-Rein CHEN, Hsinchu City (TW)

(73) Assignee: AVID Electronics Corp., Hsinchu City (TW)

(21) Appl. No.: 14/107,939

(22) Filed: Dec. 16, 2013

(30) Foreign Application Priority Data
Aug. 19, 2013 (TW) 102129606

(51) Int. Cl. H04W 48/10; H04W 76/02

(52) U.S. Cl. CPC H04W 48/10; H04W 76/021
USPC 370/254; 370/312

(57) ABSTRACT

In a control method of establishing a wireless network connection through a modulation tone, a first device broadcasts a connection modulation tone, which provides connection data. The connection data includes a network name, a password and an Internet protocol (IP) address. A second device detects the connection modulation tone and demodulates the connection modulation tone to obtain the connection data. Thus, the second device can connect to a wireless access point according to the connection data. Consequently, the user needs not to set the connection data by himself or herself, and the user only needs to move the second device near the first device to establish the connection in a convenient manner.

This application claims priority of No. 102129606 filed in Taiwan R.O.C. on Aug. 19, 2013 under 35 USC 119, the entire content of which is hereby incorporated by reference.

### BACKGROUND OF THE INVENTION

1. Field of the Invention

The invention relates in general to a control method of establishing a connection, and more particularly to a control method of establishing a wireless network connection through a modulation tone.

2. Related Art

Recently, mobile devices are popularized, and most people carry electronic devices, such as smart phones, tablet computers or notebook computers, which can connect to the Internet or network to execute Internet or network access functions at any time and any place. In addition to the 3G network provided by the telecommunication company, the electronic device may also connect to the Wi-Fi wireless access point.

An ordinary wireless access point has a network name (e.g., Service Set Identifier, SSID) and a password. Taking the tablet computer as an example, when the Wi-Fi function of the tablet computer is enabled, the tablet computer can detect the wireless signal of the wireless access point. If the tablet computer needs to connect to the wireless access point, the user has to input the correct network name (SSID) and password in the tablet computer so that the connection to the wireless access point can be established.

Because the wireless access points have been widely provided, after the Wi-Fi function of the tablet computer is enabled, the tablet computer concurrently detects multiple wireless access points. At this time, the user needs to search the name of the access point to be connected from the wireless access points, and then input the correct password to establish the connection to the wireless access point. As a result, the operation of connecting to the wireless access point is not so easy, and may bring the trouble to the user who is not familiar with the operation of the computer.

### SUMMARY OF THE INVENTION

It is therefore a main object of the invention to provide a control method of establishing a wireless network connection through a modulation tone so that the user can intuitively and rapidly establish the connection to the wireless access point.

The control method of the invention includes the steps of: broadcasting a connection modulation tone by a first device, wherein the connection modulation tone provides connection data, and the connection data comprises a network name, a password and an Internet protocol (IP) address; detecting and demodulating the connection modulation tone by a second device to obtain the connection data; and connecting the second device to a wireless access point according to the connection data.

According to the control method of the invention, the first and second devices are electronic devices that can connect to the network or Internet. When the user wants to connect the second device to the wireless access point, he or she only has to place or move the second device near the first device, so that the second device detects the connection modulation tone outputted from the first device, and the second device can obtain the connection data and establish the connection to the wireless access point. Therefore, the user needs not to set the connection data by himself or herself, and the user only needs to put the second device near the first device so that the convenience is brought to the user.

Further scope of the applicability of the present invention will become apparent from the detailed description given hereinafter. However, it should be understood that the detailed description and specific examples, while indicating preferred embodiments of the present invention, are given by way of illustration only, since various changes and modifications within the spirit and scope of the present invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention.

FIG. 1 is a schematic illustration showing a first device and a second device of the invention.

FIG. 2 is a schematic circuit block diagram showing the first device of the invention.

FIG. 3 is a schematic illustration showing a first preferred embodiment of the invention.

FIG. 4 is a schematic illustration showing a second preferred embodiment of the invention.

FIG. 5 is a schematic illustration showing a third preferred embodiment of the invention.

FIG. 6 is a schematic illustration showing a digital signal of the invention.

FIGS. 7 to 12 are schematic flow charts showing a control method of the invention.

### DETAILED DESCRIPTION OF THE INVENTION

The present invention will be apparent from the following detailed description, which proceeds with reference to the accompanying drawings, wherein the same references relate to the same elements.

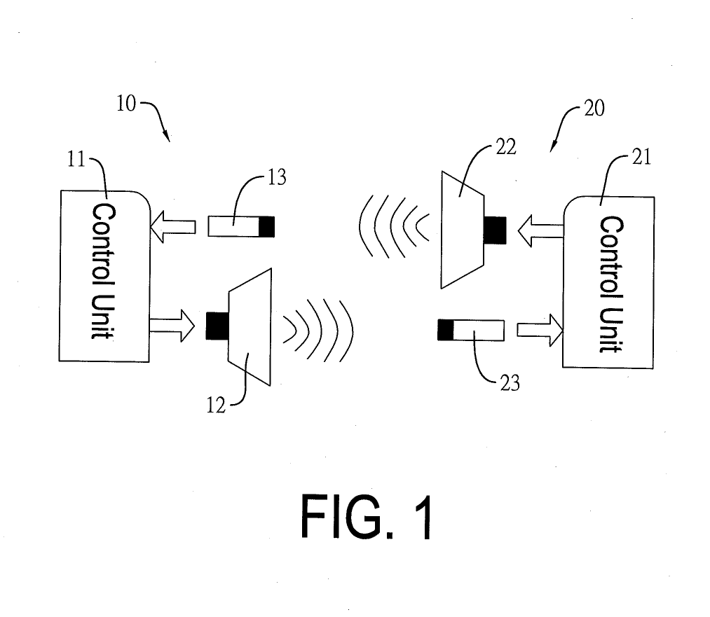

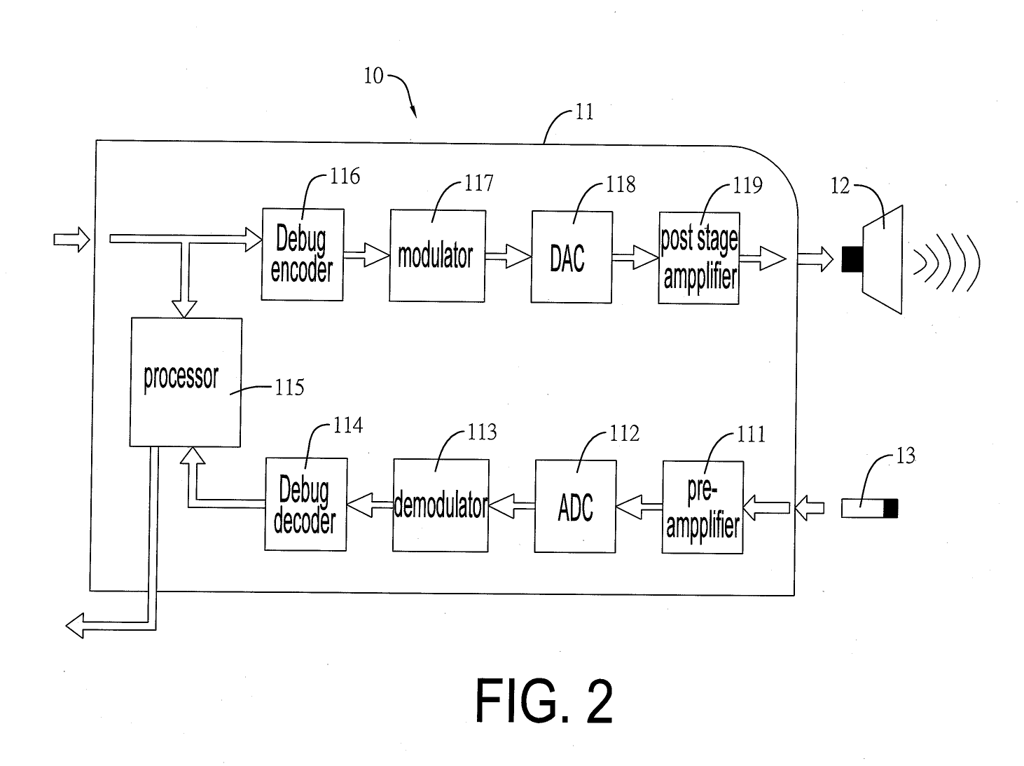

The control method of the invention of establishing a wireless network connection through a modulation tone may be executed in a device being capable of connecting to the network or Internet. Referring to FIG. 1, for example, a first device 10 and a second device 20 are electronic devices being capable of connecting to the network, such as smart phones, tablet computers, wireless access points or sounders. Referring to FIG. 2, the first device 10 serving as an example mainly includes a control unit 11, a speaker 12 and a microphone 13. The speaker 12 broadcasts the modulation tone, and the microphone 13 detects the modulation tone. In the following, how the wireless network connection is established through the modulation tone will be described with reference to several embodiments.

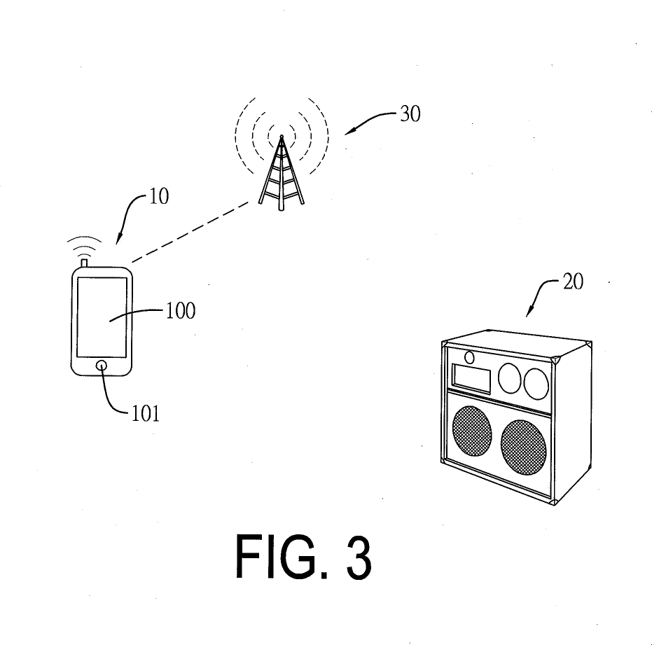

In the first preferred embodiment, as shown in FIG. 3, the first device 10 may be a smart phone, and the second device 20 may be a sounder. The first device 10 has connected to a wireless access point 30, wherein the wireless access point 30 and the first device 10 are independent devices; or the first device 10 itself may serve as a wireless access point. The second device 20 is in a disconnected status.

In the status when the first device 10 has connected to the wireless access point 30, or the first device 10 itself serves as the wireless access point, the first device 10 actively outputs a connection modulation tone through the speaker 12, wherein the connection modulation tone provides connection data, which includes a network name (SSID), a password and an Internet protocol (IP) address by which the first device 10 may connect to the wireless access point 30. The first device 10 may execute an application (APP) to provide a user interface 100. The user may operate the user interface 100 to enable the first device 10 to output the connection modulation tone through the speaker 12. Alternatively, the first device 10 may have a button 101. When the user presses the button 101, the first device 10 outputs the connection modulation tone.

The user's hand or hands can hold the first device 10 near the second device 20 so that a microphone 23 of the second device 20 can detect the connection modulation tone from the speaker 12 of the first device 10. After the second device 20 receives the connection modulation tone, the second device 20 demodulates the connection modulation tone to obtain the connection data.

After the second device 20 obtains the connection data, the second device 20 connects to the wireless access point 30 according to the connection data, and thus executes the Internet access function. After the second device 20 connects to the wireless network, the second device 20 may further generate a modulation tone, including a confirmation message, to the first device 10, so that the first device 10 can confirm that the second device 20 has indeed connected to the wireless access point 30.

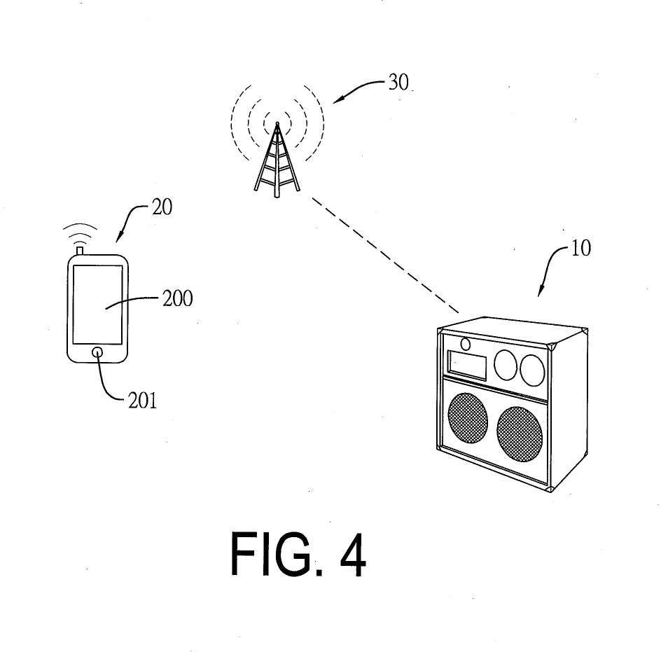

In the second preferred embodiment, as shown in FIG. 4, the first device 10 may be a sounder, and the second device 20 may be a smart phone, wherein the first device 10 has connected to the wireless access point 30, and the second device 20 is in the disconnected status.

The second device 20 can execute an application (APP) to provide a user interface 200, and the user's hand or hands can hold the second device 20 near the first device 10, and operate the user interface 200, so that the second device 20 outputs a request modulation tone, which provides a connection request, through a speaker 22. Alternatively, the second device 20 may have a button 201. When the user presses the button 201, the second device 20 immediately outputs the request modulation tone.

When the microphone 13 of the first device 10 detects the request modulation tone from the speaker 22 of the second device 20, the first device 10 demodulates the request modulation tone to obtain the connection request. The first device 10 drives the speaker 12 to broadcast the connection modulation tone, having the connection data, according to the connection request.

When the microphone 23 of the second device 20 detects the connection modulation tone from the speaker 12 of the first device 10, the second device 20 demodulates the connection modulation tone to obtain the connection data. After the second device 20 obtains the connection data, the second device 20 connects to the wireless access point 30 according to the connection data and thus executes the Internet access function.

After the second device 20 has connected to the wireless network, the second device 20 can generate a modulation tone, which includes the confirmation message, and can output the modulation tone to the first device 10, so that the first device 10 can confirm that the second device 20 has indeed connected to the wireless access point 30.

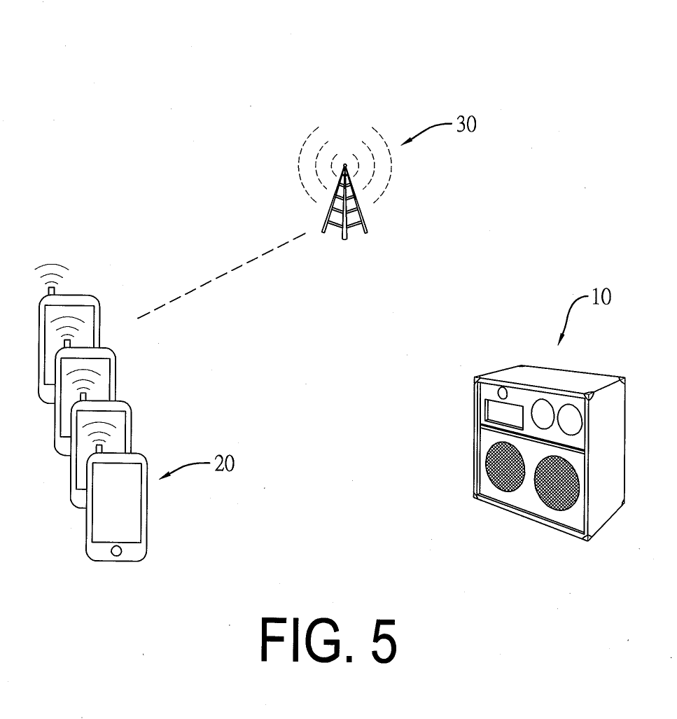

In the third preferred embodiment, the meeting room environment will be described as an example. As shown in FIG. 5, the first device 10 may be a sounder disposed in the meeting room, and the second device 20 may include a plurality of smart phones, wherein the wireless access point 30 may be disposed in the meeting room.

A connected status or a disconnected status may be established between the first device 10 and the wireless access point 30. The first device 10 actively outputs a connection modulation tone, which provides connection data. In addition to the network name (SSID), the password and the IP address of the wireless access point 30, the connection data further includes a status control command.

When the user enters the meeting room, the user's hand or hands can hold the second device 20 near the first device 10, so that the microphone 23 of the second device 20 can detect the connection modulation tone from the speaker 12 of the first device 10.

After receiving the connection modulation tone, the second device 20 demodulates the connection modulation tone to obtain the connection data.

After obtaining the connection data, the second device 20 connects to the wireless access point 30 according to the connection data, executes the Internet access function, and executes the corresponding function according to the status control command. For example, when the status control command is a mute command, the second device 20 enters the mute mode according to the mute command.

To sum up, the first device 10 broadcasts the connection modulation tone having the connection data so that the second device 20 can connect to the wireless access point 30 according to the connection data after detecting the connection modulation tone.

Referring to FIG. 2 of the invention, the control unit 11 is in charge of modulation and demodulation functions of the modulation tone. The control unit 11 includes a pre-amplifier 111, an analog-to-digital (AD) converter 112, a demodulator 113, a debug decoder 114, a processor 115, a debug encoder 116, a modulator 117, a digital-to-analog (DA) converter 118 and a post-stage amplifier 119. The demodulator 113 and the modulator 117 can execute the modulation technology, such as ASK, APSK, CPM, FSK, MFSK, MSK, OOK, PSK, QAM, TCM or OFDM.

The microphone 13 connects to the input terminal of the processor 115 through the pre-amplifier 111, the AD converter 112, the demodulator 113 and the debug decoder 114. After the microphone 13 detects a modulation tone, signal-amplifying, digitizing, demodulating and debug-decoding are performed on the modulation tone to generate a first digital signal. When the received modulation tone includes the connection data, the first digital signal generated by the demodulation naturally contains the connection data. After receiving the first digital signal, the processor 115 connects to the wireless access point according to the connection data.

The output terminal of the processor 115 is connected to the speaker 12 through the debug encoder 116, the modulator 117, the DA converter 118 and the post-stage amplifier 119. When the control unit 11 wants to output a modulation tone, the processor 115 generates a second digital signal including the connection data. Debug-encoding, modulating, analog-processing and signal-amplifying are performed on the second digital signal to generate an audio signal to be received by the speaker 12. After receiving the audio signal, the speaker 12 correspondingly outputs the modulation tone. Because the second digital signal and the audio signal include the connection data, the modulation tone naturally includes the connection data.

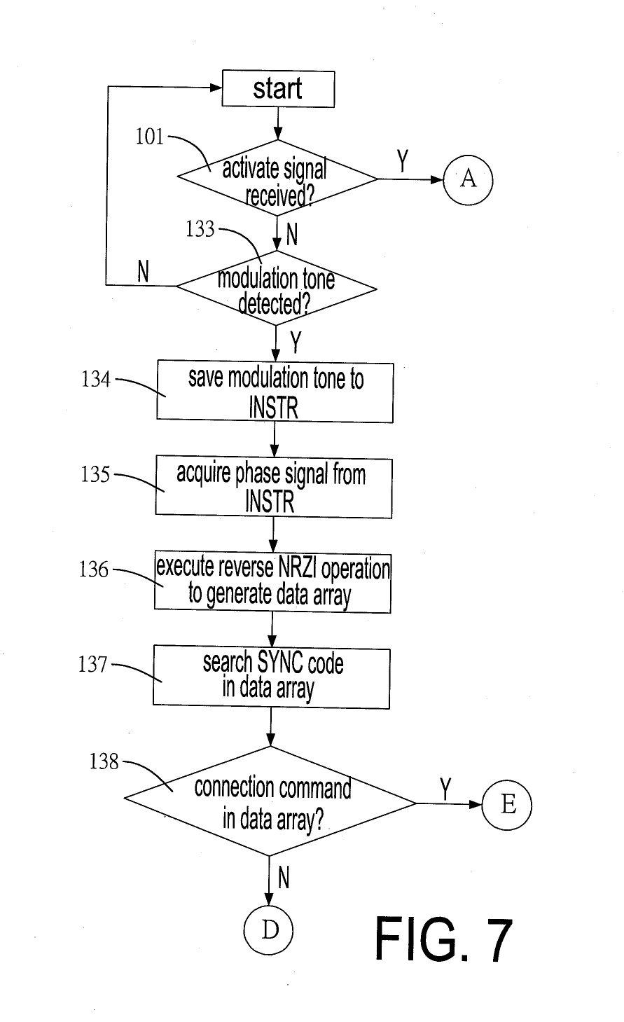

The method of generating the modulation tone will be described in detail. As shown in FIGS. 2 and 7, the processor 115 judges whether an activating signal is received in an initial status (101), wherein the activating signal is that as mentioned in the first or second embodiment. When the user operates the user interface or presses the button, the processor 115 receives the activating signal.

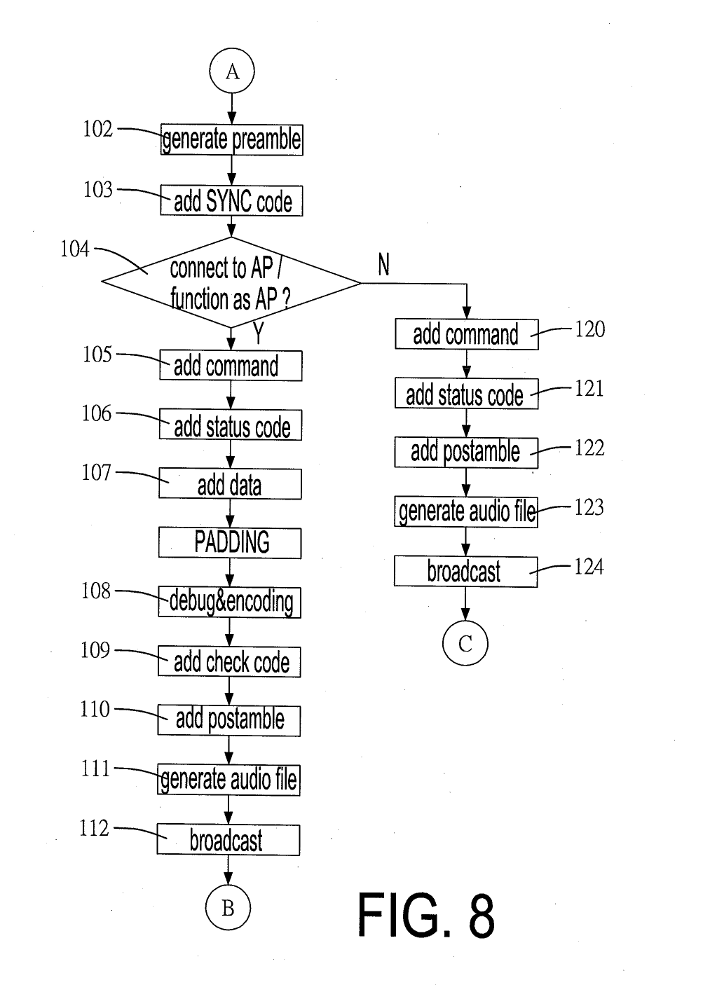

When the processor 115 receives the activating signal, as shown in FIG. 8, the processor 115 generates a preamble (102), and adds a synchronization code (synchronization pattern) to an end of the preamble (103).

After the preamble and the synchronization code are generated, the processor 115 judges whether the first device 10 has connected to the wireless access point, or whether the first device 10 itself is an access point (104).

When the processor 115 judges that the first device 10 has connected to the wireless access point, or the first device 10 itself is the wireless access point, the processor 115 sequentially adds a command to an end of the synchronization code (105), adds a status code to an end of the command (106), and adds a data code to an end of the status code. The command represents the connection command for other devices to set the network connection, the status code represents the connected status, and the data code includes the connection data, that is, the network name (SSID), password and IP address of the wireless access point.

After completing the step (107), the processor 115 debugs the command, the status code and the data code. In this preferred embodiment, the processor 115 converts the command, the status code and the data code into an 8×8 matrix and generates a check code (ECC parity) (108). The check code may be a Reed Solomon (RS) code to prevent the burst error, which disables the data correction, from occurring, a Checksum code, a CRC-8 code, a CRC-16 code or a CRC-32 code.

After generating the check code, the processor 115 adds the check code to an end of the data code (109). After adding the check code, the processor 115 adds a postamble to an end of the check code (110).

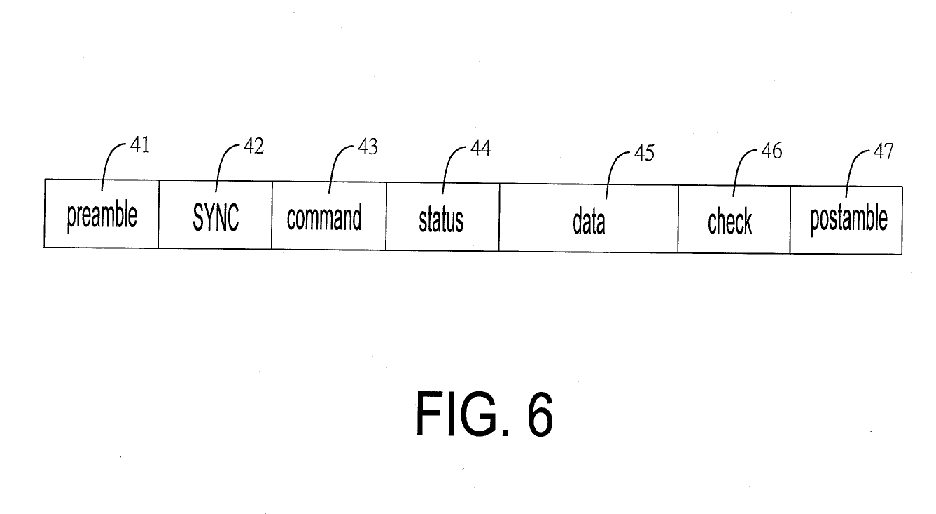

Referring to FIG. 6, a preamble 41, a synchronization code 42, a command 43, a status code 44, a data code 45, a check code 46 and a postamble 47 constitute a digital signal.

After the digital signal is generated, the debug encoder 116 and the modulator 117 convert the digital signal into an audio file (e.g., PCM or WAV file), and the DA converter 118 further converts the audio file into an audio signal (111), which is transmitted to the speaker 12. The speaker 12 broadcasts the modulation tone according to the audio signal (112), wherein the modulation tone is the connection modulation tone. The debug encoder 116 of the invention can utilize the non-return-to-zero inverted (NRZI) encoding and use the phase shift keying (PSK) modulator with the carrier of 8000 Hz to demodulate the digital signal into the audio file.

After the speaker 12 of the first device 10 broadcasts the connection modulation tone, if the second device 20 connects to the wireless access point according to the connection modulation tone, then the second device 20 broadcasts the modulation tone, which includes the confirmation message, back to the first device 10.

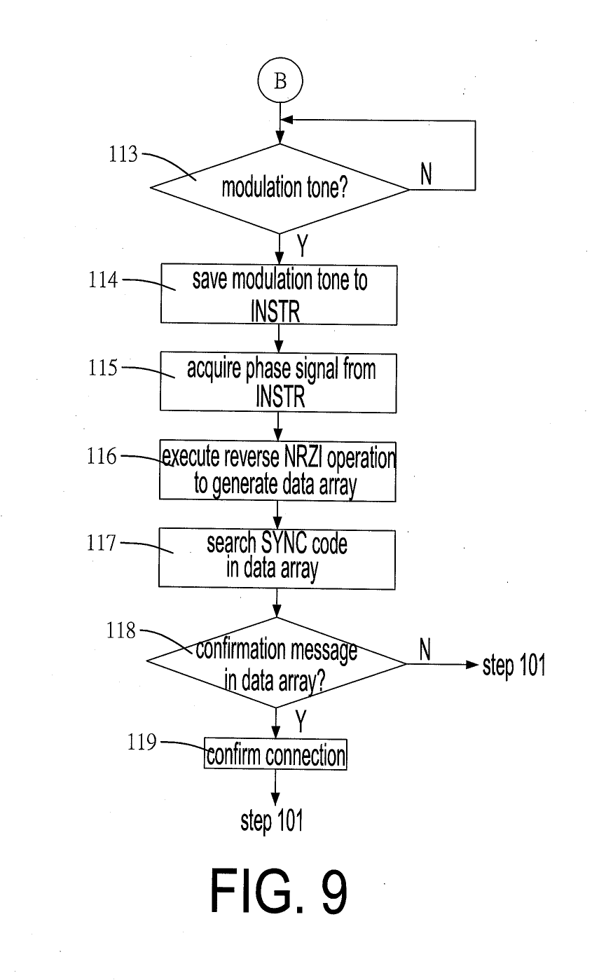

Thus, after the first device 10 broadcasts the connection modulation tone, as shown in FIG. 9, the processor 115 of the first device 10 judges whether the modulation tone from the second device 20 is detected (113). When the returned modulation tone is detected, the processor 115 saves the signal from a period of time (e.g., 1 second) before the instant of detection to a period of time (e.g., 1 second) after the instant of detection to an input string array (INSTR) (114). After completing the step (114), the processor 115 acquires a phase signal (PHSTR) with a specific frequency (Fc) from the input string array using a digital phase-locked loop circuit (115).

After obtaining the phase signal, the processor 115 defines a signal demarcation point and a signal sampling point in the phase signal to distinguish the level 0 from the level 1. Then, the processor 115 executes a reverse NRZI calculation to generate a data array (116).

After completing the step (116), the processor 115 searches the synchronization code in the data array (117). After finding the synchronization code, the processor 115 judges whether a confirmation message is present in the data array (118). When the processor 115 judges the presence of the confirmation message, the processor 115 judges that the second device 20 has connected to the wireless access point (119).

Therefore, the steps (101) to (119) correspond to the first preferred embodiment.

As shown in FIG. 8, in the step (104), when the processor 115 of the first device 10 judges that the first device 10 does not connect to the wireless access point, or that the first device 10 itself is not the wireless access point, the processor 115 adds the command to the end of the synchronization code (120), and adds the status code to the end of the command (121), wherein the command represents the connection request for requesting the setting of the wireless network, and the status code represents the disconnection from the wireless access point.

When completing the step (121), the processor 115 adds a postamble to the end of the status code (122). Consequently, the preamble, the synchronization code, the command, the status code and the postamble constitute a digital signal. After the digital signal is generated, the debug encoder 116, the modulator 117 and the DA converter 118 convert the digital signal into an audio signal (123), wherein the audio signal drives the speaker 12 to broadcast the modulation tone (124), and the modulation tone is the request modulation tone.

After the speaker 12 broadcasts the request modulation tone, the second device 20 detects the request modulation tone and demodulates the request modulation tone to obtain the command. So, the second device 20 returns a connection modulation tone back to the first device 10 according to the command (i.e., the connection request).

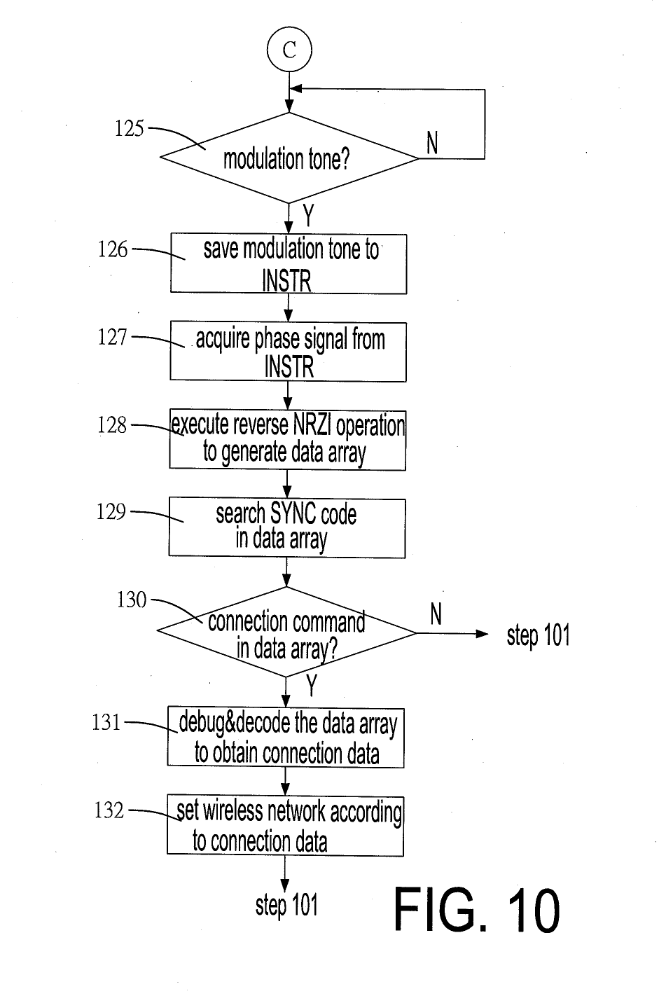

Consequently, after the speaker 12 of the first device 10 broadcasts the request modulation tone, as shown in FIG. 10, the processor 115 judges whether the microphone 13 receives a modulation tone (125). When the modulation tone is detected, the processor 115 saves the signal from a period of time (e.g., 1 second) before the instant of detection to a period of time (e.g., 1 second) after the instant of detection to an input string array (INSTR) (126). After completing the step (126), the processor 115 acquires a phase signal (PHSTR) with a specific frequency (Fc) from the input string array using a digital phase-locked loop circuit (127).

After completing the step (127), the processor 115 defines a signal demarcation point and a signal sampling point in the phase signal to distinguish the level 0 from the level 1. Then, the processor 115 executes the reverse NRZI calculation to generate a data array (128).

After completing the step (128), the processor 115 searches the synchronization code in the data array (129). When finding the synchronization code, the processor 115 judges whether the command representing the connection command is present in the data array (130). When the command is present in the data array, it represents that the data array includes the connection data, and the processor 115 debugs and decodes the data array to obtain the connection data (131). After obtaining the connection data, the processor 115 also sets the wireless network and connects to the wireless access point according to the connection data (132).

Therefore, the steps (101) to (104) and (120) to (132) correspond to the second preferred embodiment.

As shown in FIG. 7, in the step (101), when the processor 115 judges that the activating signal is not received, the processor 115 judges whether a modulation tone is detected (133). After the modulation tone is detected, the processor 115 saves the signal from 1 second before the instant of detection to 1 second after the instant of detection to an input string array (INSTR) (134). After completing the step (134), the processor 115 acquires a phase signal (PHSTR) with a specific frequency (Fc) from the input string array using a digital phase-locked loop circuit (135).

After completing the step (135), the processor 115 defines a signal demarcation point and a signal sampling point in the phase signal to distinguish the level 0 from the level 1. Then, the processor 115 executes the reverse NRZI calculation to generate a data array (136).

After completing the step (136), the processor 115 searches the synchronization code in the data array (137). When the processor 115 finds the synchronization code, it is judged that whether the command in the data array is a connection command (138).

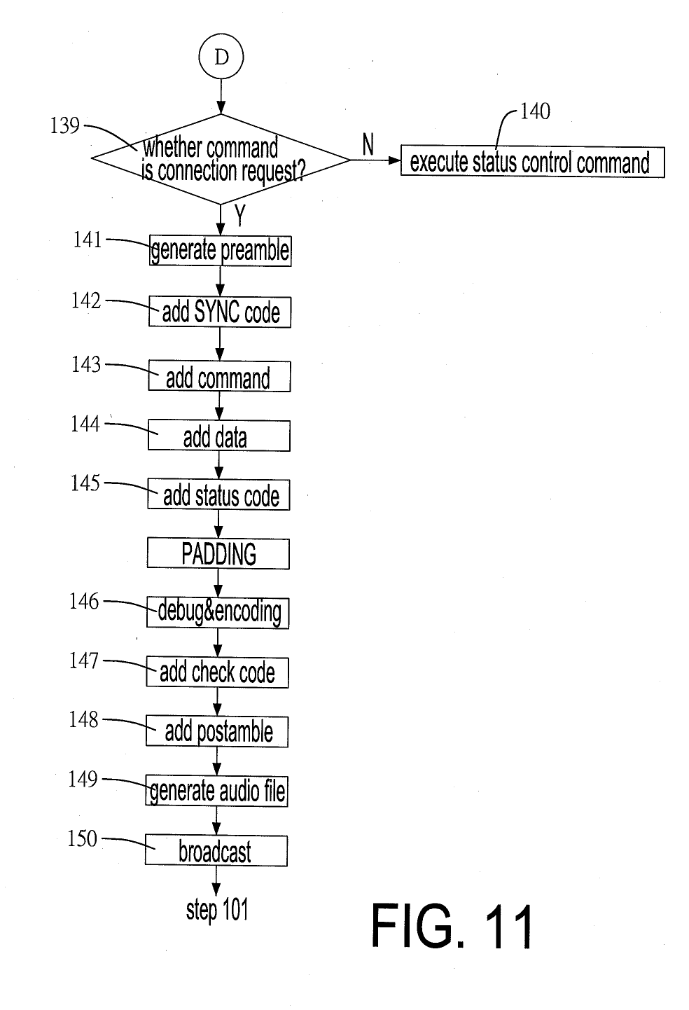

After the processor 115 judges that the command is not the connection command, as shown in FIG. 11, the processor 115 judges whether the command in the data array is the connection request (139). If the command in the data array is not the connection request, then the processor 115 obtains a status control command from the data array to execute the corresponding operation (140). For example, when the status control command is the mute command, the mute mode is entered.

In the step (139), if the command in the data array is the connection request, then it represents that the device for outputting the modulation tone in the step (133) wants to connect to the wireless access point, and the processor 115 generates a preamble (141), adds the synchronization code to the end of the preamble (142), adds the command to the end of the synchronization code (143), adds the data code to the end of the command (144) and adds the status code to the end of the data code (145). The data code includes the network name (SSID), password and IP address, by which the connection to an access point may be established.

After completing the step (145), the processor 115 debugs and encodes the command and the data code. In this preferred embodiment, the processor 115 converts the command and the data code into the 8×8 matrix and generates a check code (ECC parity) (146).

After completing the step (146), the processor 115 adds the check code to the end of the data code (147). After adding the check code, the processor 115 adds the postamble to the end of the check code (148) to generate the digital signal. After the digital signal is generated, the debug encoder 116, the modulator 117 and the DA converter 118 convert the digital signal into an audio signal (149), wherein the audio signal drives the speaker 12 to broadcast the connection modulation tone (150), so that another device can connect to the wireless access point according to the connection data after detecting the connection modulation tone.

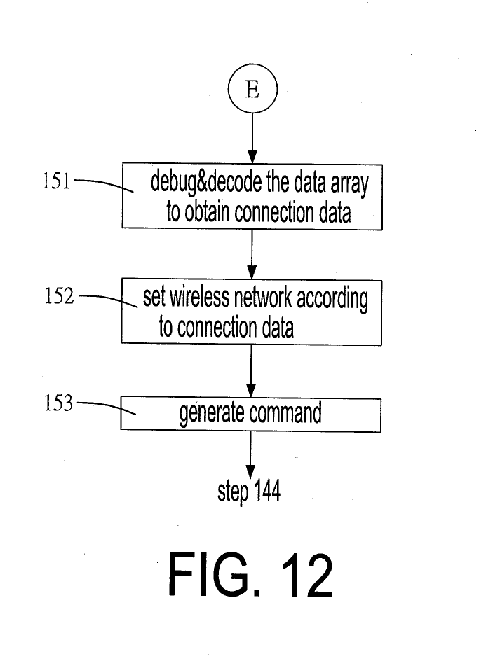

As shown in FIG. 7, in the step (138), if the command in the data array is the connection command, then it represents that the data array includes the connection data. As shown in FIG. 12, the processor 115 debugs and decodes the data array to obtain the connection data (151). After obtaining the connection data, the processor 115 sets the wireless network according to the connection data so that the connection to the wireless access point can be established (152).

After completing the step (152), the processor 115 generates a command (153), wherein the command represents that the processor 115 has completed the confirmation message of the connection data setting. After completing the step (153), the processor 115 executes the steps (144) to (150) to generate the modulation tone including the confirmation message and to output the modulation tone to another device. When the another device receives the modulation tone, the another device can demodulate the modulation tone to obtain the command. Thus, it is confirmed that the first device 10 has completed the connection data setting according to the confirmation message.

In summary, the invention enables the electronic device to obtain the connection data through the detection of the modulation tone, and the electronic device can connect to the wireless access point according to the connection data, or the electronic device can output the connection modulation tone for another electronic device to connect to the wireless access point. Consequently, the user needs not to search the wireless network and set the network name and the password, and the convenience may be brought to the user.

While the present invention has been described by way of examples and in terms of preferred embodiments, it is to be understood that the present invention is not limited thereto. To the contrary, it is intended to cover various modifications. Therefore, the scope of the appended claims should be accorded the broadest interpretation so as to encompass all such modifications.

What is claimed is:

1. A control method of establishing a wireless network connection, comprising the steps of:
broadcasting a connection modulation tone by a first device, wherein the connection modulation tone provides connection data, and the connection data comprises a network name, a password and an Internet protocol (IP) address;
detecting and demodulating the connection modulation tone by a second device to obtain the connection data; and
connecting the second device to a wireless access point according to the connection data.

2. The control method according to claim 1, wherein:
before the step of broadcasting the connection modulation tone by the first device, the second device broadcasts a request modulation tone according to an operation of a user; and
the first device receives the request modulation tone from the second device and broadcasts the connection modulation tone after receiving the request modulation tone.

3. The control method according to claim 1, wherein the first device broadcasts the connection modulation tone according to an operation of a user.

4. The control method according to claim 1, wherein the first device and the wireless access point are independent devices, and the first device broadcasts the connection modulation tone when connecting to the wireless access point.

5. The control method according to claim 2, wherein the first device and the wireless access point are independent devices, and the first device broadcasts the connection modulation tone when connecting to the wireless access point.

6. The control method according to claim 3, wherein the first device and the wireless access point are independent devices, and the first device broadcasts the connection modulation tone when connecting to the wireless access point.

7. The control method according to claim 1, wherein the first device is the wireless access point.

8. The control method according to claim 2, wherein the first device is the wireless access point.

9. The control method according to claim 3, wherein the first device is the wireless access point.

10. The control method according to claim 1, wherein in the step of broadcasting the connection modulation tone by the first device, the connection modulation tone further comprises a status control command.

11. The control method according to claim 2, wherein in the step of broadcasting the connection modulation tone by the first device, the connection modulation tone further comprises a status control command.

12. The control method according to claim 3, wherein in the step of broadcasting the connection modulation tone by the first device, the connection modulation tone further comprises a status control command.

13. The control method according to claim 10, wherein:
the status control command is a mute command; and
after the second device demodulates the connection modulation tone to obtain the mute command, the second device enters a mute mode.

14. The control method according to claim 1, wherein the step of generating the connection modulation tone by the first device comprises:
generating a preamble;
adding a synchronization code to an end of the preamble;
adding a command to an end of the synchronization code;
adding a status code to an end of the command;
adding a data code, which comprises the connection data, to an end of the status code;
adding a check code to an end of the data code;
adding a postamble to an end of the check code, wherein the preamble, the synchronization code, the command, the status code, the data code, the check code and the postamble constitute a digital signal;
converting the digital signal into an audio file; and
converting the audio file into an audio signal, and transmitting the audio signal to a speaker, which broadcasts the connection modulation tone according to the audio signal.

15. The control method according to claim 2, wherein the step of generating the connection modulation tone by the first device comprises:
generating a preamble;
adding a synchronization code to an end of the preamble;
adding a command to an end of the synchronization code;
adding a status code to an end of the command;
adding a data code, which comprises the connection data, to an end of the status code;
adding a check code to an end of the data code;
adding a postamble to an end of the check code, wherein the preamble, the synchronization code, the command, the status code, the data code, the check code and the postamble constitute a digital signal;
converting the digital signal into an audio file; and
converting the audio file into an audio signal, and transmitting the audio signal to a speaker, which broadcasts the connection modulation tone according to the audio signal.

16. The control method according to claim 3, wherein the step of generating the connection modulation tone by the first device comprises:
generating a preamble;
adding a synchronization code to an end of the preamble;
adding a command to an end of the synchronization code;
adding a status code to an end of the command;
adding a data code, which comprises the connection data, to an end of the status code;
adding a check code to an end of the data code;
adding a postamble to an end of the check code, wherein the preamble, the synchronization code, the command, the status code, the data code, the check code and the postamble constitute a digital signal;
converting the digital signal into an audio file; and
converting the audio file into an audio signal, and transmitting the audio signal to a speaker, which broadcasts the connection modulation tone according to the audio signal.

17. The control method according to claim 1, wherein the step of obtaining the connection data by the second device comprises:
saving the detected connection modulation tone to an input string array;
acquiring a phase signal from the input string array;
generating a data array according to the phase signal;
searching a synchronization code in the data array and judging whether the data array has a connection command; and
debugging and decoding the data array by the second device to obtain the connection data when the data array has the connection command, which represents that the data array comprises the connection data.

18. The control method according to claim 2, wherein the step of obtaining the connection data by the second device comprises:
saving the detected connection modulation tone to an input string array;
acquiring a phase signal from the input string array;
generating a data array according to the phase signal;
searching a synchronization code in the data array and judging whether the data array has a connection command; and
debugging and decoding the data array by the second device to obtain the connection data when the data array has the connection command, which represents that the data array comprises the connection data.

19. The control method according to claim 3, wherein the step of obtaining the connection data by the second device comprises:
saving the detected connection modulation tone to an input string array;
acquiring a phase signal from the input string array;
generating a data array according to the phase signal;
searching a synchronization code in the data array and judging whether the data array has a connection command; and
debugging and decoding the data array by the second device to obtain the connection data when the data array has the connection command, which represents that the data array comprises the connection data.

20. The control method according to claim 2, wherein the step of broadcasting the request modulation tone by the second device comprises:
generating a preamble;
adding a synchronization code to an end of the preamble;
adding a command, which represents a connection request, to an end of the synchronization code;
adding a status code to an end of the command;
adding a postamble to an end of the status code, wherein the preamble, the synchronization code, the command, the status code and the postamble constitute a digital signal;
converting the digital signal into an audio file; and
converting the audio file into an audio signal and transmitting the audio signal to a speaker, which broadcasts the request modulation tone according to the audio signal.
